(19) United States
(12) Patent Application Publication
(10) Pub. No.: US 2016/0356927 A1
(43) Pub. Date: Dec. 8, 2016

(54) POLARIZING FILM, PRESSURE-SENSITIVE ADHESIVE LAYER ATTACHED POLARIZING FILM, AND IMAGE DISPLAY DEVICE

(71) Applicant: NITTO DENKO CORPORATION

(72) Inventors: Atsushi Yasui, Ibaraki-shi (JP); Yuusuke Toyama, Ibaraki-shi (JP); Akinori Izaki, Ibaraki-shi (JP); Nozomi Fujino, Ibaraki-shi (JP)

(73) Assignees: NITTO DENKO CORPORATION, Ibaraki-shi, Osaka (JP); NITTO DENKO CORPORATION, Ibaraki-shi, Osaka (JP)

(21) Appl. No.: 15/101,103

(22) PCT Filed: Oct. 16, 2014
(86) PCT No.: PCT/JP2014/077557

§ 371 Date: Jun. 2, 2016

(30) Foreign Application Priority Data
Dec. 3, 2013 (JP) 2013-249957

(51) Int. Cl. G02B 1/18; G02B 5/30

(52) U.S. Cl. CPC G02B 1/18; G02B 5/3033; G02B 5/3083

(57) ABSTRACT

This polarizing film is characterized by comprising an inorganic layer on one or both surfaces of a polarizing element. The polarizing film has barrier properties against steam, and, even when used in the mode of a polarizing film with an adhesive layer, has good adhesion with the adhesive layer.

### TECHNICAL FIELD

The invention relates to a polarizing film having an inorganic layer. The polarizing film may be used to form a pressure-sensitive adhesive layer attached polarizing film, which has a pressure sensitive adhesive layer. The invention also relates to an image display device, such as a liquid crystal display device, an organic electroluminescence element-containing display device (organic EL display device), or a plasma display panel (PDP), produced using the polarizing film or the pressure-sensitive adhesive layer attached polarizing film.

### BACKGROUND ART

Liquid crystal display devices and other display devices have an image-forming mechanism including polarizing elements disposed as essential components on both sides of a liquid crystal cell, in which polarizing films are usually attached as the polarizing elements. A pressure-sensitive adhesive is commonly used to bond such polarizing films to a liquid crystal cell. When such polarizing films are bonded to a liquid crystal cell, a pressure-sensitive adhesive is generally used to bond the materials together so that optical losses can be reduced. In such a case, the adhesive is provided in advance as a pressure sensitive adhesive layer on one side of a polarizing film, and the resulting polarizing film with a pressure sensitive adhesive layer is generally used because it has some advantages such as no need for a drying process to fix the polarizing film. In general, a release film is attached to the pressure sensitive adhesive layer of the pressure-sensitive adhesive layer attached polarizing film.

Conventionally, a polyvinyl alcohol-based film is used to form a polarizer. Such a polarizer is hygroscopic and can easily absorb water. When absorbing a large amount of water, such a polarizer tends to have degraded performance. On the other hand, such a polarizer is used to form a polarizing film, which has a transparent protective film or films provided on one or both sides of the polarizer. In order to prevent the polarizer from absorbing water, for example, a transparent protective film with low water-vapor permeability is proposed to be used in the polarizing film. Unfortunately, in order to block water effectively, the transparent protective film with low water-vapor permeability needs to have a large thickness because its water-blocking effect depends on its thickness. In addition, when the polarizing film having the transparent protective film with low water-vapor permeability is used in the form of a pressure-sensitive adhesive layer attached polarizing film, the adhesion between the pressure sensitive adhesive layer and the polarizing film will be insufficient.

It is also proposed that an inorganic thin film layer formed on the retardation plate of a circularly polarizing plate can impart gas barrier properties to the circularly polarizing plate (Patent Document 1).

### PRIOR ART DOCUMENT

### Patent Document

Patent Document 1: JP-A-2002-156524

### SUMMARY OF THE INVENTION

### Problems to be Solved by the Invention

Patent Document 1 discloses that gas barrier properties are imparted to a circularly polarizing plate by forming an inorganic thin film layer on a retardation plate. Unfortunately, this technique requires a process under conditions suitable for each type of retardation plate in order to form an inorganic thin film layer on the retardation plate. In addition, the inorganic thin film layer is not considered to be sufficiently effective in preventing a polarizer from absorbing moisture because the inorganic thin film layer-bearing retardation plate is bonded to the polarizer or the polarizing plate (transparent protective film) with an acrylic pressure sensitive adhesive. In addition, when the circularly polarizing plate is used in the form of a pressure sensitive adhesive layer-bearing circularly polarizing plate, the adhesion between the pressure sensitive adhesive layer and the circularly polarizing plate (retardation plate) is not sufficient.

It is an object of the invention to provide a polarizing film that has barrier properties against water vapor and also has good adhesion to a pressure sensitive adhesive layer when used in the form of a pressure-sensitive adhesive layer attached polarizing film. It is another object of the invention to provide a pressure-sensitive adhesive layer attached polarizing film including the polarizing film with the barrier properties and a pressure sensitive adhesive layer.

It is a further object of the invention to provide an image display device having such a polarizing film or such a pressure-sensitive adhesive layer attached polarizing film.

### Means for Solving the Problems

AS a result of investigations for solving the problems, the inventors have found the polarizing film, and the pressure-sensitive adhesive layer attached polarizing film described below and have completed the present invention.

The present invention relates to a polarizing film, including: a polarizer; and an inorganic layer or layers provided on one or both sides of the polarizer. The polarizing film of the invention may further include a transparent protective film provided on the polarizer with or without the inorganic layer(s) interposed therebetween. In a preferred mode, the inorganic layer on at least one side is an outermost layer.

The polarizing film may include a first transparent protective film is provided on a first side of the polarizer with no inorganic layer interposed therebetween, and the inorganic layer is provided on only a second side of the polarizer. The polarizing film may include the inorganic layer is provided on the second side of the polarizer with a second transparent protective film interposed therebetween.

In the polarizing film, the inorganic layer preferably includes an inorganic oxide or an inorganic nitride.

The polarizing film preferably has a water-vapor permeability of 0.000001 g/m²·day or more and 5 g/m²·day or less as measured at 40° C. and 90% RH.

In the polarizing film, the polarizer preferably has a thickness of 10 μm or less.

The polarizing film preferably has a single transmittance of 30% or more and a degree of polarization of 90% or more.

The present invention also relates to a pressure-sensitive adhesive layer attached polarizing film including the polarizing film and a pressure sensitive adhesive layer. The pressure-sensitive adhesive layer attached polarizing film includes the pressure sensitive adhesive layer provided on the organic layer of the polarizing film.

In the pressure-sensitive adhesive layer attached polarizing film, the pressure sensitive adhesive layer is provided directly on the inorganic layer, and the pressure sensitive adhesive layer preferably has an adhesive strength between the inorganic layer and the pressure sensitive adhesive layer of 15 N/25 mm or more, more preferably has an adhesive strength between the inorganic layer and the pressure sensitive adhesive layer of 20 N/25 mm or more.

In the pressure-sensitive adhesive layer attached polarizing film, the pressure sensitive adhesive layer is preferably made from an acrylic pressure sensitive adhesive including a (meth)acryl-based polymer as a base polymer.

In the pressure-sensitive adhesive layer attached polarizing film, the acrylic pressure sensitive adhesive further preferably includes a coupling agent. The coupling agent is preferably at least one selected from the group consisting of a silane coupling agent, a zirconium coupling agent, and a titanate coupling agent. The coupling agent is preferably in an amount of 0.001 to 5 parts by weight based on 100 parts by weight of the (meth)acryl-based polymer.

In the pressure-sensitive adhesive layer attached polarizing film, the acrylic pressure sensitive adhesive further may include a crosslinking agent.

The pressure-sensitive adhesive layer attached polarizing film preferably has a water-vapor permeability of 0.000001 g/m²·day or more and 5 g/m²·day or less as measured at 40° C. and 90% RH.

The present invention also relates to an image display device including the polarizing film or the pressure-sensitive adhesive layer attached polarizing film.

### Effect of the Invention

The polarizing film of the invention includes a polarizer and an inorganic layer or layers on one or both sides of the polarizer. The polarizing film of the invention may further include a transparent protective film provided on the polarizer with or without the inorganic layer(s) interposed therebetween. As mentioned above, the polarizing film of the invention has the inorganic layer, which may be provided directly on the polarizer or provided on the polarizer with a transparent protective film interposed therebetween. Therefore, the inorganic layer can effectively block the absorption of water vapor into the polarizer. Even though thin, the inorganic layer can effectively block water, in contrast to a transparent protective film with low water-vapor permeability, which needs to be thick for effective blocking of water. Since thinner modules are demanded for liquid crystal display devices and other display devices, thinner polarizer films are also demanded. The design of the polarizing film according to the invention allows the inorganic layer to effectively block water and makes it possible to provide a thinner polarizing film. In addition, the polarizing film of the invention, in which the inorganic layer may be formed directly on the polarizer, can be combined with any type of retardation film to form a circularly or elliptically polarizing plate.

The polarizing film of the invention is also effective when the polarizer used is a thin polarizer. The thin polarizer, which is a thin film, is more resistant to shrinkage than normal polarizers. Therefore, shrinkage-induced damage to an inorganic layer is smaller when the inorganic layer is provided on the thin polarizer than when the inorganic layer is provided on a normal polarizer. In addition, the amount of water vapor entering from the cross-section of the thin polarizer can be smaller because the thin polarizer is thinner than normal polarizers. Therefore, the thin polarizer is also preferable in terms of blocking water. The polarizing film of the invention has substantially the same level of optical properties as the corresponding, inorganic layer-free, polarizing film and also has good optical properties even when placed in harsh environments.

The polarizing film of the invention may be used in the form of a pressure-sensitive adhesive layer attached polarizing film. In this case, the pressure sensitive adhesive layer is provided on the inorganic layer. The inorganic layer has good adhesion to the pressure sensitive adhesive layer, which makes it possible to provide a suitable polarizing film with a pressure sensitive adhesive layer.

### BRIEF DESCRIPTION OF THE DRAWINGS

FIGS. 1(a) and 1(b) are cross-sectional views illustrating polarizing films according to the invention.

FIGS. 2(a1) and 2(a2) are cross-sectional views illustrating polarizing films according to the invention.

FIGS. 3(a1) and 3(a2) are cross-sectional views illustrating polarizing films with a pressure sensitive adhesive layer according to the invention.

### MODE FOR CARRYING OUT THE INVENTION

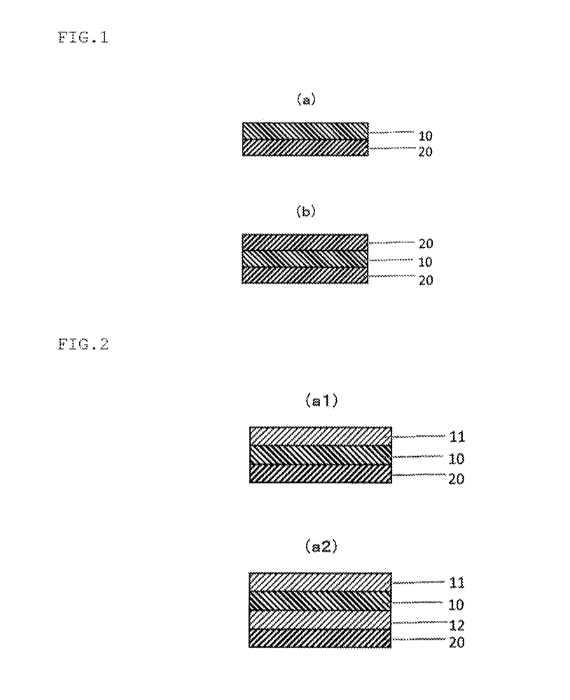

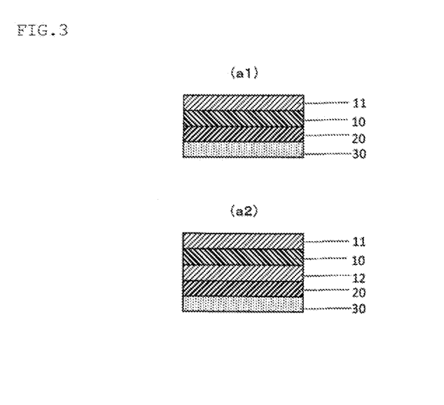

Hereinafter, embodiments of the invention will be described in detail with reference to FIGS. 1 to 3. It will be understood that the embodiments shown in FIGS. 1 and 2 are not intended to limit the invention.

As shown in FIGS. 1(a) and 1(b), the polarizing film of the invention includes a polarizer 10 and an inorganic layer or layers 20 on one or both sides (one or both of first and second sides) of the polarizer 10. The first and second sides of the polarizer may be defined interchangeably. FIG. 1(a) shows a case where the inorganic layer 20 is provided directly only on the first side of the polarizer 10. FIG. 2 (b) shows a case where the inorganic layers 20 are provided directly on both sides of the polarizer 10.

The polarizing film of the invention may include a transparent protective film or films provided one or both sides of the polarizing film shown in FIG. 1(a) or 1(b). The transparent protective film may be provided on the polarizer with or without the inorganic layer (s) interposed therebetween. In a preferred mode, the inorganic layer on at least one side is an outermost layer. FIGS. 2(a1) and 2(a2) show cases where a transparent protective film is provided on the polarizing film of FIG. 1(a). FIG. 2(a1) shows a case where a first transparent protective film 11 is provided on the first side of the polarizer 10 while the inorganic layer 20 is provided directly on the second side (the side opposite to the first side) of the polarizer 10. FIG. 2(a2) shows a case where the inorganic layer 20 is provided on the polarizer 10 with a second transparent protective film 12 interposed therebetween.

The polarizing film of the invention may have a pressure sensitive adhesive layer provided on the inorganic layer. FIGS. 3(a1) and 3(a2) show polarizing films with a pressure sensitive adhesive layer according to the invention, in which a pressure sensitive adhesive layer 30 is provided on the inorganic layer 20 of the polarizing films of FIGS. 2(a1) and 2(a2), respectively.

FIG. 2 shows a case where the polarizing film of FIG. 1(a) is provided with a transparent protective film or films, and FIG. 3 shows a case where the polarizing film of FIG. 2 is provided with a pressure sensitive adhesive layer. It will be understood that the polarizing film of FIG. 1(b) may also be provided with a first transparent protective film and/or a second transparent protective film with or without the inorganic layer(s) interposed therebetween, in which a pressure sensitive adhesive layer may also be provided on the inorganic layer. A pressure sensitive adhesive layer may also be provided on the inorganic layer of the polarizing film of FIG. 1(a) or 1(b).

The polarizing film of the invention and the pressure-sensitive adhesive layer attached polarizing film of the invention each have an inorganic layer. The inorganic layer allows the water-vapor permeability of the polarizing film to be controlled to a low level. The water-vapor permeability is preferably from 0.01 g/m²·day or more and 5 g/m²·day or less as measured at 40° C. and 90% RH. The water-vapor permeability is preferably 0.0000001 g/m²·day or more as measured at 40° C. and 90% RH because in this case, the inorganic layer can be formed with a thickness of 1,000 μm or less without involving a significant increase in thickness. The water-vapor permeability is preferably 5 g/m²·day or less because in this case, water vapor can be effectively blocked. All of the polarizing film and the pressure-sensitive adhesive layer attached polarizing film preferably have a water-vapor permeability of 0.000001 or more and 5 g/m²·day to less, more preferably 0.0001 or more and 1 g/m²·day to less.

<Polarizer>

Any of various polarizers may be used without restriction. For example, the polarizer may be a product produced by a process including adsorbing a dichroic material such as iodine or a dichroic dye to a hydrophilic polymer film such as a polyvinyl alcohol-based film, a partially-formalized polyvinyl alcohol-based film, or an ethylene-vinyl acetate copolymer-based partially-saponified film and uniaxially stretching the film or may be a polyene-based oriented film such as a film of a dehydration product of polyvinyl alcohol or a dehydrochlorination product of polyvinyl chloride. In particular, a polarizer including a polyvinyl alcohol-based film and a dichroic material such as iodine is advantageous. The thickness of the polarizer is generally, but not limited to, about 80 μm or less. In general, the thickness of the polarizer is preferably from 15 to 35 μm.

For example, a polarizer including a uniaxially-stretched polyvinyl alcohol-based film dyed with iodine can be produced by a process including immersing a polyvinyl alcohol film in an aqueous iodine solution to dye the film and stretching the film to 3 to 7 times the original length. If necessary, the film may also be immersed in an aqueous solution of boric acid, potassium iodide, or the like. If necessary, the polyvinyl alcohol-based film may be further immersed in water for washing before it is dyed. When the polyvinyl alcohol-based film is washed with water, dirt and any anti-blocking agent can be cleaned from the surface of the polyvinyl alcohol-based film, and the polyvinyl alcohol-based film can also be allowed to swell so that unevenness such as uneven dyeing can be effectively prevented. The film may be stretched before, while, or after it is dyed with iodine. The film may also be stretched in an aqueous solution of boric acid, potassium iodide, or the like or in a water bath.

A thin polarizer with a thickness of 10 μm or less may also be used. In view of thickness reduction, the thickness is preferably from 1 to 7 μm. Such a thin polarizer is less uneven in thickness, provides good visibility, and is less dimensionally-variable, and thus has high durability. It is also preferred because it can form a thinner polarizing film.

The water content of the polarizer is preferably relatively low when the inorganic layer is formed. The relatively low water content is preferable, for example, for sputtering efficiency. From these points of view, the polarizer preferably has a water content of 20% or less, more preferably 15% or less, even more preferably 5% or less. On the other hand, the polarizer preferably has a water content of 0.5% or more. A lower water content may require a longer drying time, which may significantly reduce productivity.

The water content of the polarizer may be controlled by any appropriate method. For example, the water content of the polarizer may be controlled by a method of controlling conditions in the drying step of the polarizer manufacturing process.

The water content of the polarizer can be measured by the following method. Specifically, a sample with a size of 100×100 mm is cut from the polarizer and measured for initial weight. Subsequently, the sample is dried at 120° C. for 2 hours and then measured for dry weight. The water content is determined from the following formula: water content (% by weight)={(the initial weight− the dry weight)/(the initial weight)}×100. Each measurement of the weight is performed three times, and the average of the measurements is used.

Like the water content, the water content per unit area of the polarizer is preferably relatively low when the inorganic layer is formed. The relatively low water content per unit area is preferable, for example, for sputtering efficiency. From these points of view, the polarizer preferably has a water content per unit area of 3 g/m² or less, more preferably 2 g/m² or less, even more preferably 1 g/m² or less. On the other hand, the polarizer preferably has a water content per unit area of 0.05 g/m² or more. A lower water content per unit area may require a longer drying time, which may significantly reduce productivity.

The water content per unit area of the polarizer may be controlled by any appropriate method. Examples include controlling the water content of the polarizer to a relatively low level, reducing the thickness of the polarizer, and reducing the water content of the polarizer and the thickness of the polarizer.

The water content per unit area of the polarizer can be measured by the following method. Specifically, a sample with a size of 100 mm×100 mm is cut from the polarizer and measured for initial weight. Subsequently, the sample is dried at 120° C. for 2 hours and then measured for dry weight. The water content is determined from the following formula: water content (g/m²)=(the initial weight− the dry weight)×100. Each measurement of the weight is performed three times, and the average of the measurements is used.

Typical examples of the thin polarizer include the thin polarizing films described in JP-A-51-069644, JP-A-2000-338329, WO2010/100917, PCT/JP2010/001460, Japanese Patent Application No. 2010-269002, and Japanese Patent Application No. 2010-263692. These thin polarizing films can be obtained by a process including the steps of stretching a laminate of a polyvinyl alcohol-based resin (hereinafter also referred to as PVA-based resin) layer and a stretchable resin substrate and dyeing the laminate. Using this process, the PVA-based resin layer, even when thin, can be stretched without problems such as breakage by stretching, because the layer is supported on the stretchable resin substrate.

<Transparent Protective Film>

The transparent protective film is preferably made of a material having a high level of transparency, mechanical strength, thermal stability, water barrier properties, isotropy, and other properties. Examples of such a material include polyester polymers such as polyethylene terephthalate and polyethylene naphthalate, cellulose polymers such as diacetyl cellulose and triacetyl cellulose, acryl-based polymers such as polymethyl methacrylate, styrene polymers such as polystyrene and acrylonitrile-styrene copolymers (AS resins), and polycarbonate polymers. Examples of polymers that may be used to form the transparent protective film also include polyolefin polymers such as polyethylene, polypropylene, cyclo- or norbornene-structure-containing polyolefin, and ethylene-propylene copolymers, vinyl chloride polymers, amide polymers such as nylon and aromatic polyamide, imide polymers, sulfone polymers, polyether sulfone polymers, polyether ether ketone polymers, polyphenylene sulfide polymers, vinyl alcohol polymers, vinylidene chloride polymers, vinyl butyral polymers, arylate polymers, polyoxymethylene polymers, epoxy polymers, or any blends of the above polymers. The transparent protective film may also contain any type of one or more appropriate additives. Examples of such additives include ultraviolet absorbers, antioxidants, lubricants, plasticizers, release agents, discoloration preventing agents, flame retardants, nucleating agents, antistatic agents, pigments, and colorants. The content of the thermoplastic resin in the transparent protective film is preferably 50 to 100% by weight, more preferably 50 to 99% by weight, even more preferably 60 to 98% by weight, further more preferably 70 to 97% by weight. If the content of the thermoplastic resin in the transparent protective film is 50% by weight or less, high transparency and other properties inherent in the thermoplastic resin may fail to be sufficiently exhibited.

A low-water-vapor-permeability film with a water-vapor permeability of 150 g/m²/24 hours or less may be used as the transparent protective film. In particular, the low-water-vapor-permeability film is preferably used as the second transparent protective film. This feature makes the polarizing film resistant to the entry of water from the air and also prevents the polarizing film from changing in water content. As a result, storage environment-induced curing or dimensional changes of the polarizing film can be suppressed.

The transparent protective film or films provided on one or both sides of the polarizer are preferably made of a material having a high level of transparency, mechanical strength, thermal stability, water barrier properties, isotropy, and other properties. In particular, the transparent protective film or films are preferably made of a material with a water-vapor permeability of 150 g/m²·day or less, more preferably 140 g/m²·day or less, even more preferably 120 g/m²·day or less. The water-vapor permeability can be determined by the method described below.

<Water-Vapor Permeability of Transparent Protective Film>

The water-vapor permeability (g/m²·day) of the transparent protective film is determined by measurement in the atmosphere at 40° C. and 90% R.H. for 24 hours using PERMATRAN-W manufactured by MOCON Inc.

Examples of materials that may be used to form the transparent protective film with a satisfactorily low level of water-vapor permeability as mentioned above include polyester resins such as polyethylene terephthalate and polyethylene naphthalate, polycarbonate resins, arylate resins, amide resins such as nylon and aromatic polyamide, polyolefin polymers such as polyethylene, polypropylene, and ethylene-propylene copolymers, cyclic olefin-based resins having a cyclo-structure or a norbornene structure, (meth)acrylic resins, or any blends thereof. Among these resins, polycarbonate resins, cyclic polyolefin resins, and (meth)acrylic resins are preferred, and cyclic polyolefin resins and (meth)acrylic resins are particularly preferred.

The thickness of the transparent protective film may be selected as appropriate. The transparent protective film generally has a thickness of about 1 to about 100 μm in view of strength, workability such as handleability, thin layer formability, and other properties. In particular, the thickness of the transparent protective film is preferably from 1 to 80 μm, more preferably from 3 to 60 μm.

When the transparent protective films are provided on both sides of the polarizer, the transparent protective films used on the front and back sides may be made of the same polymer material or different polymer materials.

The surface of the first transparent protective film, opposite to its surface where the polarizer is to be bonded, may be provided with a functional layer such as a hard coat layer, an anti-reflection layer, an anti-sticking layer, a diffusion layer, or an antiglare layer. The functional layer such as a hard coat layer, an anti-reflection layer, an anti-sticking layer, a diffusion layer, or an antiglare layer may be provided as part of the transparent protective film itself or as a layer independent of the transparent protective film.

The polarizer and the first or second transparent protective film may be bonded together with an adhesive. Examples of such an adhesive include isocyanate-based adhesives, polyvinyl alcohol-based adhesives, gelatin-based adhesives, vinyl adhesives, latex-based adhesives, and aqueous polyester adhesives. The adhesive is generally used in the form of an aqueous adhesive solution, which generally has a solid content of 0.5 to 60% by weight. Besides the above, ultraviolet-curable adhesives, electron beam-curable adhesives, or the like may also be used to bond the polarizer and the transparent protective film together. Electron beam-curable adhesives for use on polarizing films have good adhesion to the various transparent protective films described above. The adhesive for use in the invention may also contain a metal compound filler.

<Inorganic Layer>

The inorganic layer includes an inorganic material having a water vapor barrier function. The inorganic layer may be made of, for example, an inorganic oxide or an inorganic nitride. The inorganic layer can be formed, for example, by physical vapor deposition or chemical vapor deposition of an inorganic oxide or an inorganic nitride on the surface of the polarizer or the transparent protective film. The inorganic oxide or the inorganic nitride may be, for example, an oxide or a nitride of silicon (Si), aluminum (Al), magnesium (Mg), calcium (Ca), potassium (K), tin (Sn), sodium (Na), boron (B), titanium (Ti), lead (Pb), zirconium (Zr), yttrium (Y), or other metals. Among these inorganic oxides and inorganic nitrides, silicon oxide, silicon nitride, and aluminum oxide are preferred, which have a high level of transparency and water vapor barrier properties. One or more selected from the group consisting of these materials are preferably used. Among them, silicon oxide is particularly preferred, having good properties such as water vapor barrier properties, transparency, flexibility, and adhesion. The inorganic oxide can be expressed as MOx (M represents a metal element, and x represents the degree of oxidation), such as SiOx or AlOx. In view of gas barrier properties and transparency, the degree of oxidation x is preferably in the range of 1.3 to 1.9 when M is silicon (Si), and preferably in the range of 0.5 to 1.5 when M is aluminum (Al).

The physical vapor deposition (PVD) may be, for example, vacuum deposition, sputtering, ion plating, or ion cluster beam deposition. More specifically, a vapor-deposited film of a metal oxide can be formed using (a) a vacuum deposition method including heating a metal oxide as a raw material to form a vapor of the metal oxide and depositing the metal oxide on the surface of the object (the surface of the polarizer or the transparent protective film) from the vapor, (b) a reactive vapor deposition method including using a metal or a metal oxide as a raw material, optionally introducing oxygen gas or other gases to oxidize the raw material, and vapor-depositing the metal oxide on the surface of the object, or (c) a plasma-assisted reactive vapor deposition method in which the reaction such as oxidation is further assisted with plasma. The material to be vapor-deposited can be heated by, for example, resistance heating, high frequency induction heating, electron beam heating (EB), or other heating methods. Among the above physical vapor deposition methods, sputtering is preferred, in which an inorganic oxide or an inorganic nitride can be easily vaporized.

The chemical vapor deposition (CVD) may be, for example, plasma chemical vapor deposition, thermo-chemical vapor deposition, or photochemical vapor deposition. In particular, the chemical vapor deposition is preferably plasma CVD, in which the inorganic layer can be formed at relatively low temperatures. More specifically, the plasma CVD may be a method that includes using a monomer gas such as an organosilicon compound as a raw material for vapor deposition, using an inert gas such as argon or helium as a carrier gas, supplying an oxygen gas, an ammonia gas, or an additional gas, and subjecting the gases to a chemical reaction using a low-temperature plasma generator or the like so that a vapor-deposited thin film of an inorganic oxide such as silicon oxide or an inorganic nitride is formed on the surface of the object (the surface of the polarizer or the transparent protective film). The low-temperature plasma generator may be, for example, a high-frequency plasma generator, a pulse wave plasma generator, or a microwave plasma generator. In particular, a high-frequency plasma generator is preferred, in which highly active stable plasma can be obtained.

Examples of the monomer gas, such as the organosilicon compound, which may be used to form a vapor-deposited thin film of an inorganic oxide such as silicon oxide, include 1,1,3,3-tetramethyldisiloxane, hexamethyldisiloxane, vinyltrimethylsilane, methyltrimethylsilane, hexamethyldisilane, methylsilane, dimethylsilane, trimethylsilane, diethylsilane, propylsilane, phenylsilane, vinyltriethoxysilane, vinyltrimethoxysilane, tetramethoxysilane, tetraethoxysilane, phenyltrimethoxysilane, methyltriethoxysilane, and octamethylcyclotetrasiloxane. Among these monomer gases for vapor deposition, 1,1,3,3-tetramethyldisiloxane and hexamethyldisiloxane are preferred, which have good handleability and provide good physical properties for the vapor-deposited film.

The inorganic layer may be a monolayer structure or a multilayer structure including two or more sublayers. When the inorganic layer has such a multilayer structure, the thermal load can be reduced during the vapor deposition, which makes it possible to reduce the degradation of the polarizer or the transparent protective film and to improve the adhesion and other properties between the pressure sensitive adhesive layer and the inorganic layer. The conditions for the physical vapor deposition and the chemical vapor deposition may be designed as appropriate depending on the type of the polarizer or the transparent protective film, the thickness of the inorganic layer, and other factors.

The inorganic layer preferably has a thickness (average thickness) of 1 nm to 1,000 nm, more preferably 10 nm to 300 nm, even more preferably 30 nm to 200 nm. The inorganic layer with such a thickness can have reliable barrier properties against water vapor. On the other hand, the thickness of the inorganic layer is preferably in the above range in view of flexibility or thickness reduction.

<Pressure Sensitive Adhesive Layer>

The pressure sensitive adhesive layer may be formed using any appropriate type of pressure sensitive adhesive. Examples of the pressure sensitive adhesive include a rubber-based pressure sensitive adhesive, an acrylic pressure sensitive adhesive, a silicone-based pressure sensitive adhesive, a urethane-based pressure sensitive adhesive, a vinyl alkyl ether-based pressure sensitive adhesive, a polyvinyl alcohol-based pressure sensitive adhesive, a polyvinylpyrrolidone-based pressure sensitive adhesive, a polyacrylamide-based pressure sensitive adhesive, and a cellulose-based pressure sensitive adhesive.

Among these pressure sensitive adhesives, those having a high level of optical transparency and weather resistance or heat resistance and exhibiting an appropriate level of wettability and adhesive properties such as cohesiveness and adhesion are preferably used. An acrylic pressure sensitive adhesive is preferably used because it has such properties.

<<(Meth)Acryl-Based Polymer>>

Such an acrylic pressure sensitive adhesive includes, as a base polymer, a (meth)acryl-based polymer having an alkyl (meth)acrylate monomer unit in its main skeleton. As used herein, the term “alkyl (meth)acrylate” refers to alkyl acrylate and/or alkyl methacrylate, and “(meth)” is used in the same meaning in the description. The alkyl (meth)acrylate used to form the main skeleton of the acryl-based polymer may have a straight or branched chain alkyl group of 1 to 20 carbon atoms. Examples of the alkyl (meth)acrylate include methyl (meth)acrylate, ethyl (meth)acrylate, propyl (meth)acrylate, butyl (meth)acrylate, 2-ethylhexyl (meth)acrylate, isooctyl (meth)acrylate, isononyl (meth)acrylate, isomyristyl (meth)acrylate, and lauryl (meth)acrylate. These may be used singly or in any combination. The average carbon number of such alkyl groups is preferably from 3 to 9.

To improve adhesion or heat resistance, one or more copolymerizable monomers may be incorporated into the (meth)acryl-based polymer by copolymerization. Examples of such copolymerizable monomers include hydroxyl group-containing monomers such as 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, and (4-hydroxymethylcyclohexyl)-methyl acrylate; carboxyl group-containing monomers such as (meth)acrylic acid, carboxyethyl (meth)acrylate, carboxypentyl (meth)acrylate, itaconic acid, maleic acid, fumaric acid, and crotonic acid; acid anhydride group-containing monomers such as maleic anhydride and itaconic anhydride; caprolactone adducts of acrylic acid; sulfonic acid group-containing monomers such as styrenesulfonic acid, allylsulfonic acid, 2-(meth)acrylamido-2-methylpropanesulfonic acid, (meth)acrylamidopropanesulfonic acid, sulfopropyl (meth)acrylate, and (meth)acryloyloxynaphthalenesulfonic acid; and phosphate group-containing monomers such as 2-hydroxyethylacryloyl phosphate.

Examples of such monomers for modification also include (N-substituted) amide monomers such as (meth)acrylamide, N,N-dimethyl(meth)acrylamide, N-butyl(meth)acrylamide, N-methylol(meth)acrylamide, and N-methylolpropane(meth)acrylamide; alkylaminoalkyl (meth)acrylate monomers such as aminoethyl (meth)acrylate, N,N-dimethylaminoethyl (meth)acrylate, and tert-butylaminoethyl (meth)acrylate; alkoxyalkyl (meth)acrylate monomers such as methoxyethyl (meth)acrylate and ethoxyethyl (meth)acrylate; succinimide monomers such as N-(meth)acryloyloxymethylenesuccinimide, N-(meth)acryloyl-6-oxyhexamethylenesuccinimide, N-(meth)acryloyl-8-oxyoctamethylenesuccinimide, and N-acryloylmorpholine; maleimide monomers such as N-cyclohexylmaleimide, N-isopropylmaleimide, N-laurylmaleimide, and N-phenylmaleimide; and itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide.

Examples of modifying monomers that may also be used include vinyl monomers such as vinyl acetate, vinyl propionate, N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, N-vinylcarboxylic acid amides, styrene, α-methylstyrene, and N-vinylcaprolactam; cyanoacrylate monomers such as acrylonitrile and methacrylonitrile; epoxy group-containing acrylic monomers such as glycidyl (meth)acrylate; glycol acrylate monomers such as polyethylene glycol (meth)acrylate, polypropylene glycol (meth)acrylate, methoxyethylene glycol (meth)acrylate, and methoxypolypropylene glycol (meth)acrylate; and acrylic ester monomers such as tetrahydrofurfuryl (meth)acrylate, fluoro(meth)acrylate, silicone (meth)acrylate, and 2-methoxyethyl acrylate.

Concerning the weight ratios of all constituent monomers, the alkyl (meth)acrylate should be a main component of the (meth)acryl-based polymer, and the content of the copolymerizable monomer used to form the (meth)acryl-based polymer is preferably, but not limited to, 0 to about 20%, more preferably about 0.1 to about 15%, even more preferably about 0.1 to about 10%, based on the total weight of all constituent monomers.

Among these copolymerizable monomers, hydroxyl group-containing monomers and carboxyl group-containing monomers are preferably used in view of adhesion or durability. These monomers can serve as a reactive site to a crosslinking agent. Hydroxyl group-containing monomers and carboxyl group-containing monomers are highly reactive with intermolecular crosslinking agents and thus are preferably used to improve the cohesiveness or heat resistance of the resulting pressure-sensitive adhesive layer.

When a hydroxyl group-containing monomer and a carboxyl group-containing monomer are added as copolymerizable monomers, the content of the carboxyl group-containing monomer is preferably from 0.1 to 10% by weight, and the content of the hydroxyl group-containing monomer is preferably from 0.01 to 2% by weight, while these copolymerizable monomers should be used at the content described above. The content of the carboxyl group-containing monomer is more preferably from 0.2 to 8% by weight, even more preferably from 0.6 to 6% by weight. The content of the hydroxyl group-containing monomer is more preferably from 0.03 to 1.5% by weight, even more preferably from 0.05 to 1% by weight.

The (meth)acryl-based polymer for use in the invention generally has a weight average molecular weight in the range of 500,000 to 3,000,000. In view of durability, particularly, heat resistance, the (meth)acryl-based polymer used preferably has a weight average molecular weight of 700,000 to 2,700,000, more preferably 800,000 to 2,500,000. A weight average molecular weight of less than 500,000 is not preferred in terms of heat resistance. If the weight average molecular weight is more than 3,000,000, a large amount of a diluent solvent can be necessary for adjusting the viscosity to be suitable for coating, which may increase cost and is not preferred. The term “weight average molecular weight” refers to the value calculated as a polystyrene-equivalent molecular weight from a measurement obtained by gel permeation chromatography (GPC).

The (meth)acryl-based polymer described above can be produced by a method appropriately selected from known methods such as solution polymerization, bulk polymerization, emulsion polymerization, and various types of radial polymerization. The resulting (meth)acryl-based polymer may be any form such as a random copolymer, a block copolymer, or a graft copolymer.

In solution polymerization, for example, ethyl acetate, toluene, or the like may be used as a polymerization solvent. An example of solution polymerization includes performing the reaction under a stream of inert gas such as nitrogen in the presence of a polymerization initiator typically under the reaction conditions of a temperature of about 50 to about 70° C. and a time period of about 5 to about 30 hours.

Any appropriately selected polymerization initiator, chain transfer agent, emulsifier, or other agents may be used for radical polymerization. The weight average molecular weight of the (meth)acryl-based polymer can be adjusted by controlling the amount of the polymerization initiator or the chain transfer agent or by controlling the reaction conditions.

The amount of these agents may be adjusted as appropriate depending on the type of these agents.

Examples of the polymerization initiator include, but are not limited to, azo initiators such as 2,2′-azobisisobutyronitrile, 2,2′-azobis(2-amidinopropane)dihydrochloride, 2,2′-azobis[2-(5-methyl-2-imidazolin-2-yl)propane]dihydrochloride, 2,2′-azobis(2-methylpropionamidine)disulfate, 2,2′-azobis(N,N′-dimethyleneisobutylamidine), and 2,2′-azobis[N-(2-carboxyethyl)-2-methylpropionamidine]hydrate (VA-057 manufactured by Wako Pure Chemical Industries, Ltd.); persulfates such as potassium persulfate and ammonium persulfate; peroxide initiators such as di(2-ethylhexyl) peroxydicarbonate, di(4-tert-butylcyclohexyl) peroxydicarbonate, di-sec-butyl peroxydicarbonate, tert-butyl peroxyneodecanoate, tert-hexyl peroxypivalate, tert-butyl peroxypivalate, dilauroyl peroxide, di-n-octanoyl peroxide, 1,1,3,3-tetramethylbutylperoxy-2-ethyl hexanoate, di(4-methylbenzoyl) peroxide, dibenzoyl peroxide, tert-butyl peroxyisobutyrate, 1,1-di(tert-hexylperoxy)cyclohexane, tert-butyl hydroperoxide, and hydrogen peroxide; and a redox system initiator including a combination of a peroxide and a reducing agent, such as a combination of a persulfate and sodium hydrogen sulfite or a combination of a peroxide and sodium ascorbate.

These polymerization initiators may be used singly or in combination of two or more. The total content of the polymerization initiator(s) is preferably from about 0.005 to about 1 part by weight, more preferably from about 0.02 to about 0.5 parts by weight, based on 100 parts by weight of the monomers.

For example, when the (meth)acryl-based polymer with a weight average molecular weight as shown above is produced using 2,2′-azobisisobutyronitrile as a polymerization initiator, the amount of the polymerization initiator is preferably from about 0.06 to about 0.2 parts by weight based on 100 parts by weight of all the monomers.

Examples of the chain transfer agent include lauryl mercaptan, glycidyl mercaptan, mercaptoacetic acid, 2-mercaptoethanol, thioglycolic acid, 2-ethylhexyl thioglycolate, and 2,3-dimercapto-1-propanol. The chain transfer agents may be used singly or in combination of two or more. The total content of the chain transfer agent(s) should be about 0.1 parts by weight or less, based on 100 parts by weight of all the monomers.

Examples of the emulsifier for use in emulsion polymerization include anionic emulsifiers such as sodium lauryl sulfate, ammonium lauryl sulfate, sodium dodecylbenzenesulfonate, ammonium polyoxyethylene alkyl ether sulfate, and sodium polyoxyethylene alkyl phenyl ether sulfate; and nonionic emulsifiers such as polyoxyethylene alkyl ether, polyoxyethylene alkyl phenyl ether, polyoxyethylene fatty acid ester, and polyoxyethylene-polyoxypropylene block polymers. These emulsifiers may be used singly or in combination of two or more.

The emulsifier may be a reactive emulsifier. Examples of such an emulsifier having an introduced radically-polymerizable functional group, such as a propenyl group or an allyl ether group, include AQUALON HS-10, HS-20, KH-10, BC-05, BC-10, and BC-20 (all manufactured by DKS Co., Ltd.) and ADEKA REASOAP SE10N (manufactured by ADEKA CORPORATION). The reactive emulsifier is preferred because after polymerization, it can improve water resistance by being incorporated into the polymer chain. Based on 100 parts by weight of all the monomers, the emulsifier is preferably used in an amount of 0.3 to 5 parts by weight, more preferably 0.5 to 1 part by weight, in view of polymerization stability or mechanical stability.

<<Crosslinking Agent>>

The pressure sensitive adhesive preferably further contains a crosslinking agent. A polyfunctional compound may be added to the pressure sensitive adhesive, and such a polyfunctional compound may be an organic crosslinking agent or a polyfunctional metal chelate. Examples of the organic crosslinking agent include an epoxy crosslinking agent, an isocyanate crosslinking agent, an imine crosslinking agent, and a peroxide crosslinking agent. One or more of these crosslinking agents may be used singly or in combination. The organic crosslinking agent is preferably an isocyanate crosslinking agent. The polyfunctional metal chelate is a compound containing a polyvalent metal covalently or coordinately bonded to an organic compound. Examples of the polyvalent metal atom include Al, Cr, Zr, Co, Cu, Fe, Ni, V, Zn, In, Ca, Mg, Mn, Y, Ce, Sr, Ba, Mo, La, Sn, and Ti. The organic compound has a covalent or coordinate bond-forming atom such as an oxygen atom. Examples of the organic compound include an alkyl ester, an alcohol compound, a carboxylic acid compound, an ether compound, and a ketone compound.

The crosslinking agent is preferably an isocyanate crosslinking agent and/or a peroxide crosslinking agent. Examples of compounds for use as isocyanate crosslinking agents include isocyanate monomers such as tolylene diisocyanate, chlorophenylene diisocyanate, tetramethylene diisocyanate, xylylene diisocyanate, diphenylmethane diisocyanate, and hydrogenated diphenylmethane diisocyanate, and isocyanate, isocyanurate, or biuret compounds produced by adding any of these isocyanate monomers to trimethylolpropane or other compounds; and urethane prepolymer type isocyanates produced by addition reaction of any of these isocyanate compounds with polyether polyols, polyester polyols, acrylic polyols, polybutadiene polyols, polyisoprene polyols, or other polyols. Particularly preferred is a polyisocyanate compound such as one selected from the group consisting of hexamethylene diisocyanate, hydrogenated xylylene diisocyanate, and isophorone diisocyanate, or a polyisocyanate compound derived therefrom. Examples of one selected from the group consisting of hexamethylene diisocyanate, hydrogenated xylylene diisocyanate, and isophorone diisocyanate, or a polyisocyanate compound derived therefrom include hexamethylene diisocyanate, hydrogenated xylylene diisocyanate, isophorone diisocyanate, polyol-modified hexamethylene diisocyanate, polyol-modified hydrogenated xylylene diisocyanate, trimer-type hydrogenated xylylene diisocyanate, and polyol-modified isophorone diisocyanate. The listed polyisocyanate compounds are preferred because their reaction with a hydroxyl group quickly proceeds as if an acid or a base contained in the polymer acts as a catalyst, which particularly contributes to the rapidness of the crosslinking.

Any peroxide capable of generating active radical species upon heating or exposure to light and capable of crosslinking the base polymer in the pressure-sensitive adhesive can be used appropriately. In view of workability or stability, a peroxide with a one-minute half-life temperature of 80° C. to 160° C. is preferably used, and a peroxide with a one-minute half-life temperature of 90° C. to 140° C. is more preferably used.

Examples of peroxides that may be used include di(2-ethylhexyl) peroxydicarbonate (one-minute half-life temperature: 90.6° C.), di(4-tert-butylcyclohexyl) peroxydicarbonate (one-minute half-life temperature: 92.1° C.), di-sec-butyl peroxydicarbonate (one-minute half-life temperature: 92.4° C.), tert-butyl peroxyneodecanoate (one-minute half-life temperature: 103.5° C.), tert-hexyl peroxypivalate (one-minute half-life temperature: 109.1° C.), tert-butyl peroxypivalate (one-minute half-life temperature: 110.3° C.), dilauroyl peroxide (one-minute half-life temperature: 116.4° C.), di-n-octanoyl peroxide (one-minute half-life temperature: 117.4° C.), 1,1,3,3-tetramethylbutylperoxy-2-ethyl hexanoate (one-minute half-life temperature: 124.3° C.), di(4-methylbenzoyl) peroxide (one-minute half-life temperature: 128.2° C.), dibenzoyl peroxide (one-minute half-life temperature: 130.0° C.), tert-butyl peroxyisobutyrate (one-minute half-life temperature: 136.1° C.), and 1,1-di(tert-hexylperoxy)cyclohexane (one-minute half-life temperature: 149.2° C.). In particular, di(4-tert-butylcyclohexyl) peroxydicarbonate (one-minute half-life temperature: 92.1° C.), dilauroyl peroxide (one-minute half-life temperature: 116.4° C.), and dibenzoyl peroxide (one-minute half-life temperature: 130.0° C.) are preferably used because they can provide higher crosslinking reaction efficiency.

The half life of a peroxide, which is an indicator of how fast the peroxide can be decomposed, refers to the time required for the remaining amount of the peroxide to reach one half of the original amount. The decomposition temperature required for a certain half life time and the half life time obtained at a certain temperature are shown in catalogs furnished by manufacturers, such as Organic Peroxide Catalog, 9th Edition, May, 2003, furnished by NOF CORPORATION.

The crosslinking agent is preferably used in an amount of 0.01 to 20 parts by weight, more preferably 0.03 to 10 parts by weight, based on 100 parts by weight of the (meth)acryl-based polymer. If the amount of the crosslinking agent is less than 0.01 parts by weight, the adhesive may tend to have insufficient cohesive strength, and foaming may occur during the heating of the adhesive. On the other hand, if it is more than 20 parts by weight, the pressure sensitive adhesive may have insufficient moisture resistance and may easily peel off in a reliability test and other tests.

The above isocyanate crosslinking agents may be used singly or in combination of two or more. The total content of the isocyanate crosslinking agent(s) is preferably from 0.01 to 2 parts by weight, more preferably from 0.02 to 2 parts by weight, even more preferably from 0.05 to 1.5 parts by weight, based on 100 parts by weight of the (meth)acryl-based polymer. The content may be appropriately determined taking into account cohesive strength, the ability to prevent delamination in a durability test, or other properties.

The above peroxides may be used singly or in combination of two or more. The total content of the peroxide(s) is preferably from 0.01 to 2 parts by weight, more preferably from 0.04 to 1.5 parts by weight, even more preferably from 0.05 to 1 part by weight, based on 100 parts by weight of the (meth)acryl-based polymer. The content may be appropriately selected in these ranges for control of workability, reworkability, crosslinking stability, removability, or other properties.

The amount of decomposition of the peroxide can be determined, for example, by a method of measuring the peroxide residue after the reaction process by high performance liquid chromatography (HPLC).

More specifically, for example, after the reaction process, about 0.2 g of each pressure sensitive adhesive is taken out and immersed in 10 ml of ethyl acetate and subjected to shaking extraction at 25° C. and 120 rpm for 3 hours in a shaker, and then allowed to stand at room temperature for 3 days. Subsequently, 10 ml of acetonitrile is added, and the resulting mixture is shaken at 25° C. and 120 rpm for 30 minutes. About 10 μl of the liquid extract obtained by filtration through a membrane filter (0.45 μm) is subjected to HPLC by injection and analyzed so that the amount of the peroxide after the reaction process is determined.

<Coupling Agent>

The pressure sensitive adhesive preferably contains a coupling agent. The pressure sensitive adhesive layer made from a coupling agent-containing pressure-sensitive adhesive can have improved adhesion to the inorganic layer. Examples of the coupling agent include a silane coupling agent, a zirconium coupling agent, and a titanate coupling agent. One or more of these coupling agents may be selected and used.

Any conventionally known silane coupling agents may be used. Examples include epoxy group-containing silane coupling agents such as γ-glycidoxypropyltrimethoxysilane, γ-glycidoxypropyltriethoxysilane, γ-glycidoxypropylmethyldiethoxysilane, and 2-(3,4-epoxycyclohexyl)ethyltrimethoxysilane; amino group-containing silane coupling agents such as 3-aminopropyltrimethoxysilane, N-2-(aminoethyl)-3-aminopropylmethyldimethoxysilane, and 3-triethoxysilyl-N-(1,3-dimethylbutylidene)propylamine; (meth)acrylic group-containing silane coupling agents such as 3-acryloxypropyltrimethoxysilane and 3-methacryloxypropyltriethoxysilane; and isocyanate group-containing silane coupling agents such as 3-isocyanatopropyltriethoxysilane.

A compound having a titanium or zirconium atom and at least one reactive group (e.g., a hydrophilic alkoxy group reactive with a hydroxyl group) may be used as a titanium or zirconium coupling agent. Another compound having a titanium or zirconium atom, the reactive hydrophilic group, and a hydrophobic organic functional group (hydrophobic group) having a carboxyl group, a phosphate group, a pyrophosphate group, a phosphite group, a sulfonyl group, an amino group, or other groups may also be used as a titanium or zirconium coupling agent.

The titanium coupling agent may be, for example, a titanium alkoxide (alkyl titanate) or a titanium chelate (a compound containing titanium coordinated or bonded to an alkoxy group or other groups and an additional organic functional group). Examples of the titanium coupling agent include isopropyltriisostearoyl titanate, isopropyltri-n-dodecylbenzenesulfonyl titanate, isopropyltris(dioctylpyrophosphate) titanate, tetraisopropylbis(dioctylphosphite) titanate, tetraoctylbis(ditridecylphosphite) titanate, tetra(2,2-diallyloxymethyl-1-butyl)bis(di-tridecyl)phosphite titanate, bis(dioctylpyrophosphate)oxyacetate titanate, bis(dioctylpyrophosphate)ethylene titanate, isopropyltrioctanoyl titanate, isopropyldimethacryloylisostearoyl titanate, isopropylisostearoyldiacryl titanate, isopropyltri(dioctylphosphate) titanate, isopropyltricumylphenyl titanate, isopropyltri(N-aminoethyl-aminoethyl) titanate, tetraisopropyl titanate, tetra-n-butyl titanate, butyl titanate dimer, tetrakis(2-ethylhexyl) titanate, tetrastearyl titanate, tetramethyl titanate, diethoxybis(acetylacetonato)titanium, diisopropylbis(acetylacetonato)titanium, diisopropoxybis(ethylacetoacetate)titanium, isopropoxy(2-ethyl-1,3-hexanediolato)titanium, di(2-ethylhexoxy)bis(2-ethyl-1,3-hexanediolato)titanium, di-n-butoxybis(triethanolaminato)titanium, titanium tetraacetylacetonate, hydroxybis(lactato)titanium, dicumylphenyloxyacetate titanate, and diisostearoylethylene titanate.

Specific examples of the titanium coupling agent include PLENACT series manufactured by Ajinomoto Fine-Techno Co., Inc., such as PLENACT KR-TTS, KR-46B, KR-55, KR-41B, KR-38S, KR-138S, KR-238S, 338X, KR44, and KR9SA; ORGATIX series manufactured by Matsumoto Fine Chemical Co., Ltd., such as ORGATIX TA-10, TA-25, TA-22, TA-30, TC-100, TC-200, TC-401, and TC-750; and products manufactured by Nippon Soda Co., Ltd., such as A-1, B-1, TOT, TST, TAA, TAT, TLA, TOG, TBSTA, A-10, TBT, B-2, B-4, B-7, B-10, TBSTA-400, TTS, TOA-30, TSDMA, TTAB, and TTOP.

The zirconium coupling agent may be, for example, a zirconium alkoxide or a zirconium chelate (a compound containing titanium coordinated or bonded to an alkoxy group or other groups and an additional organic functional group). Examples of the zirconium coupling agent include ethylenically unsaturated zirconate-containing compounds and neoalkoxyzirconate-containing compounds, such as neoalkoxytrisneodecanoyl zirconate, neoalkoxytris(dodecyl)benzenesulfonyl zirconate, neoalkoxytris(dioctyl)phosphate zirconate, neoalkoxytris(dioctyl)pyrophosphate zirconate, neoalkoxytris(ethylenediamino)ethyl zirconate, neoalkoxytris(m-amino)phenyl zirconate, tetra(2,2-diallyloxymethyl)butyl, di(ditridecyl)phosphito zirconate, neopentyl(diallyl)oxy, trineodecanoyl zirconate, neopentyl(diallyl)oxy, tri(dodecyl)benzene-sulfonyl zirconate, neopentyl(diallyl)oxy, tri(dioctyl)phosphato zirconate, neopentyl(diallyl)oxy, tri(dioctyl)pyro-phosphato zirconate, neopentyl(diallyl)oxy, tri(N-ethylenediamino)ethyl zirconate, neopentyl(diallyl)oxy, tri(m-amino)phenyl zirconate, neopentyl(diallyl)oxy, trimethacryl zirconate, neopentyl(diallyl)oxy, triacryl zirconate, dineopentyl(diallyl)oxy, diparaminobenzoyl zirconate, dineopentyl(diallyl)oxy, di(3-mercapto)propionic zirconate, zirconium(IV) 2,2-bis(2-propenolatomethyl)butanolato, cyclodi[2,2-(bis2-propenolatomethyl)butanolato]pyrophosphat o-O,O, neoalkoxytrisneodecanoyl zirconate, neoalkoxytris(dodecyl)benzenesulfonyl zirconate, neoalkoxytris(dioctyl)phosphate zirconate, neoalkoxytris(dioctyl)pyrophosphate zirconate, neoalkoxytris(ethylenediamino)ethyl zirconate, and neoalkoxytris(m-amino)phenyl zirconate. Examples of the zirconium coupling agent also include tetra-n-propoxyzirconium, tetra-n-butoxyzirconium, zirconium tetraacetylacetonate, zirconium tributoxyacetylacetonate, zirconium tributoxystearate, zirconium dibutoxybis(acetylacetonate), zirconium dibutoxybis(acetylacetonate), zirconium tributoxyethylacetoacetate, and zirconium monobutoxyacetylacetonate bis(ethylacetoacetate).

Specific examples of the zirconium coupling agent include Ken-React series manufactured by Kenrich Petrochemicals, Inc., such as Ken-React KZ55, NZ01, NZ09, NZ12, NZ38, NZ44, NZ97, NZ33, NZ39, NZ37, NZ66A, and KZTPP; and ORGATIX series manufactured by Matsumoto Fine Chemical Co., Ltd., such as ORGATIX ZA-40, ZA-65, ZC-150, ZC-540, ZC-570, and ZC-580.

The coupling agent is preferably added in an amount of 5 parts by weight or less, more preferably in an amount of 0.001 to 5 parts by weight, to 100 parts by weight of the base polymer (e.g., the (meth)acryl-based polymer). The use of 0.001 parts by weight or more of the coupling agent is effective in improving the adhesion to the inorganic layer. On the other hand, the use of more than 5 parts by weight of the coupling agent may affect the adhesive properties. The content of the coupling agent is preferably from 0.01 to 3 parts by weight, more preferably from 0.1 to 1 part by weight.

If necessary, the pressure sensitive adhesive may further contain a tackifier, a plasticizer, a filler of glass fibers, glass beads, metal powder, or any other inorganic powder, a pigment, a colorant, a filler, an antioxidant, an ultraviolet absorber, or other various additives without departing from the object of the invention. Fine particles may also be added to the adhesive so that a pressure sensitive adhesive layer with light diffusion properties can be formed.

When the pressure sensitive adhesive is used to form a pressure sensitive adhesive layer, it is preferred that the total content of the crosslinking agent should be controlled and that the effect of the crosslinking temperature or the crosslinking time should be carefully taken into account.

The crosslinking temperature and the crosslinking time may be controlled depending on the type of the crosslinking agent to be used. The crosslinking temperature is preferably 170° C. or lower.

The crosslinking process may be performed at the temperature where the process of drying the pressure sensitive adhesive layer is performed, or an independent crosslinking process may be performed after the drying process.

The crosslinking time may be determined in view of productivity or workability. The crosslinking time is generally from about 0.2 to about 20 minutes, preferably from about 0.5 to about 10 minutes.

The pressure sensitive adhesive layer can be formed by, for example, a method including applying the pressure sensitive adhesive to a release-treated separator or the like, removing the polymerization solvent and other components by drying to form a pressure sensitive adhesive layer, and then transferring the pressure sensitive adhesive layer onto the inorganic layer of the polarizing film. Alternatively, the pressure sensitive adhesive layer can be formed by a method including applying the pressure sensitive adhesive to the inorganic layer of the polarizing film and removing the polymerization solvent and other components by drying to form a pressure sensitive adhesive layer on the polarizing film. In the process of applying the pressure sensitive adhesive, if necessary, one or more solvents other than the polymerization solvent may be newly added to the pressure sensitive adhesive.

A silicone release liner is preferably used as the release-treated separator. The pressure sensitive adhesive composition may be applied to such a liner and dried to form a pressure sensitive adhesive layer. In this process, any appropriate method may be used for drying the pressure sensitive adhesive, depending on the purpose. Preferably, a method of heating and drying the coating is used. The heating and drying temperature is preferably from 40° C. to 200° C., more preferably from 50° C. to 180° C., even more preferably from 70° C. to 170° C. When the heating temperature falls within the ranges, a pressure-sensitive adhesive with excellent adhesive properties can be obtained.

The drying may be performed for any appropriate time. The drying time is preferably from 5 seconds to 20 minutes, more preferably from 5 seconds to 10 minutes, even more preferably from 10 seconds to 5 minutes.

The surface of the inorganic layer of the polarizing film may also be covered with an anchor layer or subjected to any adhesion facilitating treatment such as a corona treatment or a plasma treatment before the pressure sensitive adhesive layer is formed thereon. The surface of the pressure sensitive adhesive layer may also be subjected to an adhesion facilitating treatment.

Any of various coating agents may be used to form the anchor layer for improving adhesion, controlling refractive index, imparting conductivity, or achieving other purposes. A filler, particles, a conductive polymer, or other materials may be used in the coating agent, depending on the purpose. Examples of a binder resin that may be used in the coating agent include, but are not limited to, epoxy resins, isocyanate resins, polyurethane resins, polyester resins, polymers containing amino groups in the molecule, ester urethane resins, and organic reactive group-containing resins (polymers) such as various acrylic resins containing oxazoline groups or other groups.

Various methods may be used to form the pressure sensitive adhesive layer. Examples of such methods include roll coating, kiss roll coating, gravure coating, reverse coating, roll brush coating, spray coating, dip roll coating, bar coating, knife coating, air knife coating, curtain coating, lip coating, and extrusion coating with a die coater or other coaters.

The thickness of the pressure sensitive adhesive layer is typically, but not limited to, about 1 to about 100 μm, preferably 2 to 50 μm, more preferably 2 to 40 μm, even more preferably 5 to 35 μm.

When the surface of the pressure sensitive adhesive layer is exposed, the pressure sensitive adhesive layer may be protected by a release-treated sheet (separator) until it is actually used.

Examples of the material used to form such a separator include a plastic film such as a polyethylene, polypropylene, polyethylene terephthalate, or polyester film, a porous material such as a paper sheet, a cloth, or a nonwoven fabric, and appropriate thin materials such as a net, a foamed sheet, a metal foil, and a laminate thereof. A plastic film is advantageously used because of its good surface smoothness.

Such a plastic film may be of any type capable of protecting the pressure sensitive adhesive layer. For example, such a plastic film may be a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, or an ethylene-vinyl acetate copolymer film.

The separator generally has a thickness of about 5 to about 200 μm, preferably about 5 to about 100 μm. If necessary, the separator may be subjected to a release treatment and an anti-pollution treatment with a silicone, fluoride, long-chain alkyl, or fatty acid amide release agent, a silica powder or the like, or subjected to an antistatic treatment of coating type, kneading and mixing type, vapor-deposition type, or the like. In particular, when the surface of the separator is appropriately subjected to a release treatment such as a silicone treatment, a long-chain alkyl treatment, or a fluorine treatment, the releasability from the pressure sensitive adhesive layer can be further improved.

The release-treated sheet used in the preparation of the pressure-sensitive adhesive layer attached polarizing film may be used by itself as a separator for the pressure-sensitive adhesive layer attached polarizing film, so that the process can be simplified.

The polarizing film and any other optical film or films may be placed on one another to form a laminate. Examples of such other optical films include a reflector, a transflector, a retardation film (including a wavelength plate such as a half or quarter wavelength plate), a viewing angle compensation film, a brightness enhancement film, and any other optical layer that can be used to form a liquid crystal display device or the like. One or more layers of any of these optical components may be used together with the polarizing film to form a laminate for practical use.

The optical film including a laminate of the polarizing film and the optical layer may be formed by a method of stacking them one by one in the process of manufacturing a liquid crystal display device or the like. However, an optical film formed in advance by lamination is advantageous in that it can facilitate the process of manufacturing a liquid crystal display device or the like because it has stable quality and good assembling workability. In the lamination, any appropriate bonding means such as a pressure sensitive adhesive layer may be used. When the polarizing film and any other optical layer are bonded together, their optical axes may be each aligned at an appropriate angle, depending on the desired retardation properties or other desired properties.

The pressure-sensitive adhesive layer attached polarizing film of the invention is preferably used to form a variety of image display devices such as liquid crystal display devices. Liquid crystal display devices may be formed according to conventional techniques. Specifically, a liquid crystal display device may be typically formed using any conventional technique including properly assembling a display panel such as a liquid crystal cell, a pressure-sensitive adhesive layer attached polarizing film, and optional components such as lighting system components, and incorporating a driving circuit, except that the pressure-sensitive adhesive layer attached polarizing film used is according to the invention. The liquid crystal cell to be used may also be of any type such as TN type, STN type, n type, VA type, or IPS type.

Any desired liquid crystal display device may be formed, such as a liquid crystal display device including a display panel such as a liquid crystal cell and the pressure-sensitive adhesive layer attached polarizing film or films placed on one or both sides of the display panel, or a liquid crystal display device further including a backlight or a reflector in a lighting system. In such a case, the pressure-sensitive adhesive layer attached polarizing film or films according to the invention may be placed on one or both sides of a display panel such as a liquid crystal cell. When the optical films are provided on both sides, they may be the same or different. The process of forming a liquid crystal display device may also include placing an appropriate component such as a diffusion layer, an antiglare layer, an anti-reflection film, a protective plate, a prism array, a lens array sheet, a light diffusion sheet, or a backlight in one or more layers at an appropriate position or positions.

Next, an organic electroluminescence device (organic EL display device or OLED) will be described. An organic EL display device generally includes a transparent substrate and a light-emitting element (an organic electroluminescence light-emitting element) that is formed on the substrate by stacking a transparent electrode, an organic light-emitting layer, and a metal electrode in this order. In this structure, the organic light-emitting layer is a laminate of different organic thin films. Concerning such a laminate, various combinations are known, such as a laminate of a hole injection layer including a triphenylamine derivative or the like and a light-emitting layer including a fluorescent organic solid material such as anthracene, a laminate of such a light-emitting layer and an electron injection layer including a perylene derivative or the like, and a laminate of the hole injection layer, the light-emitting layer, and the electron injection layer.

The organic EL display device emits light based on the mechanism that when a voltage is applied between the transparent electrode and the metal electrode, holes and electrons are injected into the organic light-emitting layer and recombined to produce energy, which excites the fluorescent material so that light is emitted when the excited fluorescent substance goes back to the ground state. The mechanism of the recombination during the process is similar to that in common diodes. As expected from this feature, current and emission intensity exhibit strong nonlinearity accompanied by rectification with respect to applied voltages.

In the organic EL display device, at least one of the electrodes must be transparent for the output of the emission from the organic light-emitting layer, and a transparent electrode made of a transparent electrical conductor such as indium tin oxide (ITO) is generally used as an anode. On the other hand, to facilitate the electron injection and increase the luminous efficiency, it is important to use a low-work-function substance for the cathode, and an electrode of a metal such as Mg—Ag or Al—Li is generally used as the cathode.

In the organic EL display device with such a structure, the organic light-emitting layer is formed of a very thin film with a thickness of about 10 nm. Thus, light is almost entirely transmitted through the organic light-emitting layer, as well as through the transparent electrode. In the off-state, therefore, light incident on the surface of the transparent substrate is transmitted through the transparent electrode and the organic light-emitting layer and reflected from the metal electrode to return to and exit from the surface of the transparent substrate, so that the screen of the organic EL display device looks like a mirror surface when it is viewed from the outside.

An organic EL display device has an organic electroluminescence light-emitting element including an organic light-emitting layer for emitting light upon voltage application, a transparent electrode provided on the front side of the organic light-emitting layer, and a metal electrode provided on the back side of the organic light-emitting layer. In this organic EL display device, a polarizing plate may be provided on the front side of the transparent electrode, and a retardation plate may be provided between the transparent electrode and the polarizing plate.

The retardation plate and the polarizing plate act to polarize the light incident from the outside and reflected from the metal electrode. Thus, their polarization action is effective in preventing the mirror surface of the metal electrode from being visible from the outside. Specifically, the retardation plate may include a quarter wavelength plate, and the angle between the polarization directions of the polarizing plate and the retardation plate may be set at π/4, so that the mirror surface of the metal electrode can be completely shielded.

Of external light incident on this organic EL display device, therefore, only a linearly polarized light component is transmitted by the polarizing plate. The linearly polarized light is generally turned into elliptically polarized light by the retardation plate. Particularly when the retardation plate is a quarter wavelength plate and when the angle between the polarization directions of the polarizing plate and the retardation plate is π/4, the linearly polarized light is turned into circularly polarized light.

The circularly polarized light is transmitted through the transparent substrate, the transparent electrode, and the organic thin film, reflected from the metal electrode, transmitted through the organic thin film, the transparent electrode, and the transparent substrate again, and turned into linearly polarized light again by the retardation plate. The linearly polarized light has a polarization direction orthogonal to that of the polarizing plate and thus cannot pass through the polarizing plate. As a result, the mirror surface of the metal electrode can be completely shielded.

In order to block mirror reflection as described above, the organic EL display device may use an elliptically or circularly polarizing plate having a combination of a retardation plate and a polarizing plate, which is bonded to the organic EL panel with a pressure sensitive adhesive layer interposed therebetween. Alternatively, without being directly bonded to the organic EL panel, the elliptically or circularly polarizing plate may be bonded to a touch panel with a pressure sensitive adhesive layer interposed therebetween, and the resulting laminate may be used to form the organic EL panel.

### EXAMPLES

Hereinafter, the invention will be more specifically described with reference to examples, which, however, are not intended to limit the invention. In each example, “parts” and “%” are all by weight. Unless otherwise specified below, the conditions of standing at room temperature include 23° C. and 65% RH in all cases.

<Measurement of Weight Average Molecular Weight of (Meth)Acryl-Based Polymer>

The weight average molecular weight of (meth)acryl-based polymers was determined using gel permeation chromatography (GPC).

Analyzer: HLC-8120GPC manufactured by TOSOH CORPORATION

Columns: GM7000H_{XL}+GMH_{XL}+GMH_{XL}. manufactured by TOSOH CORPORATION

Column size: Each 7.8 mmφ×30 cm, 90 cm in total

Column temperature: 40° C.

Flow rate: 0.8 ml/minute

Injection volume: 100 μl

Eluent: Tetrahydrofuran

Detector: Differential refractometer (RI)

Standard sample: Polystyrene

<Transparent Protective Films>

Transparent Protective Film 1

A 40-μm-thick, lactone-ring-structure-containing (meth)acrylic resin film (water-vapor permeability 96 g/m²·day) was subjected to a corona treatment and then used as transparent protective film 1 (represented by acryl (40) in Table 2).

Transparent Protective Film 2

A 20-μm-thick, lactone-ring-structure-containing (meth)acrylic resin film (water-vapor permeability 48 g/m²·day) was subjected to a corona treatment and then used as transparent protective film 2 (represented by acryl (20) in Table 2).

Transparent Protective Film 3

A 40-μm-thick, cyclic polyolefin film (ZEONOR manufactured by Zeon Corporation, water-vapor permeability 11 g/m²·day) was subjected to a corona treatment and then used as transparent protective film 3 (represented by COP (40) in Table 2).

<Preparation of Thin Polarizer>

A thin polarizing coating was prepared as follows. First, a laminate including an amorphous PET substrate and a 9-μm-thick PVA layer formed thereon was subjected to auxiliary in-air stretching at a stretching temperature of 130° C. to form a stretched laminate. Subsequently, the stretched laminate was subjected to dyeing to form a dyed laminate, and the dyed laminate was subjected to stretching in an aqueous boric acid solution at a stretching temperature of 65° C. to a total stretch ratio of 5.94 times, so that an optical film laminate was obtained which had a 4-μm-thick PVA layer stretched together with the amorphous PET substrate. As a result of such two-stage stretching, an optical film laminate having a 5-μm-thick PVA layer formed on the amorphous PET substrate was successfully obtained. In the PVA layer, PVA molecules were highly oriented. The PVA layer formed a highly-functional polarizing coating in which iodine adsorbed by the dyeing formed a polyiodide ion complex oriented highly in a single direction. In Table 2, the resulting thin polarizing coating is represented by PVA (5). Table 2 also shows the water content of the thin polarizing coating.

<Preparation of Thin Polarizing Film (A1)>

A first transparent protective film (transparent protective film 1 described above (acryl (40))) was bonded to the polarizing coating of the optical film laminate with a polyvinyl alcohol-based adhesive being applied to the surface of the polarizing coating. Subsequently, the amorphous PET substrate was removed, so that a polarizing film having the thin polarizing coating was obtained. Hereinafter, this product is referred to as the thin polarizing film (A1).

<Preparation of Other Thin Polarizing Films>

Thin polarizing films (A2) to (A5) were each prepared as in the preparation of the thin polarizing film (A1), except that the first transparent protective film shown in Table 2 was used instead in the preparation of the thin polarizing film. In the case of the thin polarizing film (A4), no transparent protective film was used, and in the case of the thin polarizing film (AS), transparent protective films were provided on both sides.

<Preparation of Polarizer>

A 60-μm-thick polyvinyl alcohol film with an average degree of polymerization of 2,400 and a degree of saponification of 99.9% by mole was immersed in warm water at 30° C. for 60 seconds so that it was allowed to swell. The film was then immersed in an aqueous solution of 0.3% iodine/potassium iodide (0.5/8 in weight ratio) and dyed while stretched to 3.5 times. The film was then stretched to a total stretch ratio of 6 times in an aqueous boric ester solution at 65° C. After the stretching, the film was dried in an oven at 40° C. for 3 minutes to give a polarizer (20 μm in thickness). In Table 2, the polarizer is represented by PVA (20). Table 2 also shows the water content of the polarizer.

<Preparation of Polarizing Film (A6)>

A first transparent protective film (transparent protective film 1 described above (acryl (40))) was bonded to the polarizer with a polyvinyl alcohol-based adhesive being applied to one side of the polarizer so that a polarizing film (A6) was obtained.

<Preparation of Pressure Sensitive Adhesive>

A reaction vessel equipped with a condenser tube, a nitrogen inlet tube, a thermometer, and a stirrer was charged with 99 parts of butyl acrylate, 1 part of 4-hydroxybutyl acrylate, 3 parts of azobisisobutyronitrile as an initiator (based on 100 parts of all the monomers), and ethyl acetate. The mixture was allowed to react at 60° C. for 7 hours under a nitrogen gas stream. Ethyl acetate was then added to the reaction liquid to form a solution containing an acryl-based polymer with a weight average molecular weight of 1,000,000 (30% by weight in solid concentration). Based on 100 parts of the solid in the acryl-based polymer solution, 0.1 parts of trimethylolpropane xylylene diisocyanate (Takenate D110N manufactured by Mitsui Chemicals, Inc.), 0.3 parts of dibenzoyl peroxide, and 0.075 parts of γ-glycidoxypropylmethoxysilane (KBM-403 manufactured by Shin-Etsu Chemical Co., Ltd.) were added to the acryl-based polymer solution to form an acrylic pressure sensitive adhesive solution (C1).

<Preparation of Other Pressure Sensitive Adhesives>

Acrylic pressure sensitive adhesive solutions (C2) to (C5) were each prepared as described above (in the section “Preparation of pressure sensitive adhesive”), except that the composition of all the monomers, the type or added amount of the crosslinking agent, or the type or added amount of the coupling agent was changed as shown in Table 3.

### Example 1

### Formation of Inorganic Layer

Silicon oxide was vapor-deposited by sputtering to form a 100-nm-thick inorganic layer (B1) on the surface of the polarizer (polarizing coating) of the thin polarizing film (A1), so that an inorganic layer-bearing polarizing film was obtained.

### Examples 2 to 8

Inorganic layer-bearing polarizing films were obtained as in Example 1, except that the material for forming the inorganic layer and/or the thickness of the inorganic layer was changed as shown in Table 1 when the inorganic layer was formed.

### Examples 9 to 12

Inorganic layer-bearing polarizing films were obtained as in Example 1, except that the thin polarizing film (A1) was replaced with that shown in Table 1 when the inorganic layer was formed.

### Example 13

### Preparation of Pressure-Sensitive Adhesive Layer Attached Polarizing Film

The acrylic pressure sensitive adhesive solution (C1) was uniformly applied to the surface of a silicone release agent-treated polyethylene terephthalate film (separator) with a fountain coater and then dried in an air circulation-type thermostatic oven at 155° C. for 2 minutes, so that a 20-μm-thick pressure-sensitive adhesive layer was formed on the surface of the separator. Subsequently, the pressure sensitive adhesive layer-bearing separator was attached to the inorganic layer (B1) of the inorganic layer-bearing polarizing film obtained in Example 1, so that a pressure-sensitive adhesive layer attached polarizing film was obtained.

### Examples 14 to 18

Pressure-sensitive adhesive layer attached polarizing film were prepared as in Example 13, except that the acrylic pressure sensitive adhesive solution (C1) was replaced with that shown in Table 1 when the pressure sensitive adhesive layer was formed.

### Examples 19 and 20

Pressure-sensitive adhesive layer attached polarizing film were prepared as in Example 13, except that the inorganic layer-bearing material shown in Table 1 was used instead of the inorganic layer-bearing polarizing film obtained in Example 1.

### Comparative Examples 4 to 6

The pressure-sensitive adhesive layer attached polarizing film were prepared as in Example 13, except that the thin polarizing film (A1), (A3), or (A5) was used with no inorganic layer provided thereon as shown in Table 1.

The inorganic layer-bearing polarizing films and the pressure-sensitive adhesive layer attached polarizing film obtained in the examples and the comparative examples were each evaluated as described below. As shown in Table 1, the thin polarizing film (A1), (A3), or (A5) was used with no inorganic layer provided thereon in Comparative Examples 1 to 3 and subjected to the evaluation. Table 1 shows the evaluation results.

<Water-Vapor Permeability>

The water-vapor permeability (g/m²·day) of the inorganic layer-bearing polarizing film or the pressure-sensitive adhesive layer attached polarizing film was determined by measurement in the atmosphere at 40° C. and 90% R.H. using PERMATRAN-W manufactured by MOCON Inc.

<Adhesive Strength>

A 25-mm-wide piece was cut from the pressure-sensitive adhesive layer attached polarizing film obtained in each of the examples and the comparative examples. The separator was removed from the cut piece, and the remaining part was used as a sample. The pressure sensitive adhesive layer of the sample was bonded to a SiO₂-coated film (Tetolight OES). The peel strength (N/25 mm) between the pressure sensitive adhesive layer and the inorganic layer was measured with Autograph while the sample was peeled off at an angle of 90 degrees and a pulling rate of 300 mm/minute.

<Optical Properties (Measurement of Single Transmittance and Degree of Polarization)>

The inorganic layer-bearing polarizing films, the pressure-sensitive adhesive layer attached polarizing film, and the thin polarizing films (the samples) obtained in the examples and the comparative examples were measured for optical properties (single transmittance and degree of polarization) using an integrating sphere-equipped spectrophotometric transmittance meter (DOT-3C manufactured by Murakami Color Research Laboratory). The measurement of the optical properties was performed before (for the initial stage) and after (for optical reliability) each sample was stored under an atmosphere at 60° C. and 90% R.H. in a humidified oven for 120 hours. The inorganic layer-bearing polarizing films and the thin polarizing films were each subjected alone to the measurement. The pressure-sensitive adhesive layer attached polarizing film were each subjected to the measurement as follows. A sample was obtained by removing the separator from the pressure-sensitive adhesive layer attached polarizing film and then bonded to a 0.7-mm-thick non-alkali glass sheet (EG-XG manufactured by Corning Incorporated) using a laminator. The resulting laminate was autoclaved at 50° C. and 0.5 MPa for 15 minutes, so that the sample was completely bonded to the non-alkali glass sheet. The sample was then subjected to the measurement.

The degree of polarization was calculated from the formula below using the transmittance (parallel transmittance Tp) of a laminate of the same two polarizing films with their transmission axes parallel to each other and the transmittance (crossed transmittance Tc) of a laminate of the same two polarizing films with their transmission axes orthogonal to each other.

Degree (%) of polarization={(Tp−Tc)/(Tp+Tc)}^{1/2}×100

Each transmittance was expressed as the Y value, which was obtained through luminosity correction using the two-degree field (illuminant C) according to JIS Z 8701 when the transmittance for completely polarized light obtained through a Glan-Taylor prism polarizer was normalized to 100%.

The organic layer-bearing polarizing film of the invention and the pressure-sensitive adhesive layer attached polarizing film of the invention can achieve a single transmittance of 30% or more and a degree of polarization of 90% or more and thus have good optical properties. The single transmittance is preferably 35% or more, more preferably 42% or more. The degree of polarization is preferably 90% or more, more preferably 98% or more, even more preferably 99% or more.

TABLE 1

| | | | | | | Evaluations | | | | | |
|---|---|---|---|---|---|---|---|---|---|---|---|
| | | | | | | | | Optical properties | | | |
| | | | | | | | | | | Optical | |
| | | | | | | | | Initial stage | | reliability after | |
| | | | Inorganic | | Type of | | | | Degree | storage at 60° C. and | |
| | | | layer | | pressure- | | | Single | of | 90% R.H. for 120 hours | |
| | | Type of | (B) | | sensitive | Water-vapor | Adhesive | trans- | polar- | Single | Degree of |
| | | polarizing | | Thickness | adhesive | permeability | strength | mittance | ization | transmittance | polarization |
| | | film (A) | Type | (nm) | layer (C) | (g/m² · day) | (N/25 mm) | (%) | (%) | (%) | (%) |
| Difference | Example 1 | A1 | B1 | 100 | — | 0.12 | — | 42.5 | 99.99 | 42.5 | 99.99 |
| in | Example 2 | A1 | B2 | 100 | — | 0.11 | — | 42.5 | 99.99 | 42.5 | 99.99 |
| material | Example 3 | A1 | B3 | 100 | — | 0.14 | — | 42.5 | 99.99 | 42.5 | 99.99 |
| Difference | Example 4 | A1 | B1 | 10 | — | 1.40 | — | 42.5 | 99.99 | 42.5 | 99.99 |
| in | Example 5 | A1 | B1 | 50 | — | 0.23 | — | 42.5 | 99.99 | 42.5 | 99.99 |
| thickness | Example 6 | A1 | B1 | 150 | — | 0.10 | — | 42.5 | 99.99 | 42.5 | 99.99 |
| | Example 7 | A1 | B1 | 200 | — | 0.07 | — | 42.5 | 99.99 | 42.5 | 99.99 |
| | Example 8 | A1 | B1 | 500 | — | 0.02 | — | 42.5 | 99.99 | 42.5 | 99.99 |
| Difference | Example 9 | A2 | B1 | 100 | — | 0.11 | — | 42.1 | 99.99 | 42.1 | 99.99 |
| in | Example 10 | A3 | B1 | 100 | — | 0.12 | — | 42.2 | 99.99 | 42.2 | 99.99 |
| polarizing | Example 11 | A4 | B1 | 100 | — | 0.10 | — | 42.4 | 99.99 | 42.4 | 99.99 |
| plate | | | | | | | | | | | |
| Normal | Example 12 | A6 | B1 | 100 | — | 0.24 | — | 42.5 | 99.99 | 42.5 | 99.99 |
| polarizer | Example 13 | A1 | B1 | 100 | C1 | 0.12 | 21 | 42.5 | 99.99 | 42.5 | 99.99 |
| With | Example 14 | A1 | B1 | 100 | C2 | 0.13 | 21 | 42.5 | 99.99 | 42.5 | 99.99 |
| adhesive | Example 15 | A1 | B1 | 100 | C3 | 0.11 | 22 | 42.5 | 99.99 | 42.5 | 99.99 |
| | Example 16 | A1 | B1 | 100 | C4 | 0.12 | 25 | 42.5 | 99.99 | 42.5 | 99.99 |
| | Example 17 | A1 | B1 | 100 | C5 | 0.13 | 25 | 42.5 | 99.99 | 42.5 | 99.99 |
| Normal | Example 18 | A6 | B1 | 100 | C1 | 0.22 | 20 | 42.5 | 99.99 | 42.5 | 99.99 |
| polarizer | | | | | | | | | | | |
| With | Example 19 | A1 | B2 | 100 | C3 | 0.14 | 22 | 42.5 | 99.99 | 42.5 | 99.99 |
| adhesive, | Example 20 | A1 | B3 | 100 | C3 | 0.14 | 21 | 42.5 | 99.99 | 42.5 | 99.99 |
| Difference | | | | | | | | | | | |
| in | | | | | | | | | | | |
| material | | | | | | | | | | | |
| Protection | Comparative | A1 | Absent | — | — | 80 | — | 42.5 | 99.99 | 84.3 | 40.53 |
| of one | Example 1 | | | | | | | | | | |
| side | | | | | | | | | | | |
| Protection | Comparative | A3 | Absent | — | — | 7 | — | 42.5 | 99.99 | 70.7 | 46.33 |
| of one | Example 2 | | | | | | | | | | |
| side | | | | | | | | | | | |
| Protection | Comparative | A5 | Absent | — | — | 35 | — | 42.5 | 99.99 | 42.5 | 99.99 |
| of both | Example 3 | | | | | | | | | | |
| sides | | | | | | | | | | | |
| Protection | Comparative | A1 | Absent | — | C3 | 77 | 11 | 42.5 | 99.99 | 66.2 | 60.46 |
| of one | Example 4 | | | | | | | | | | |
| side | | | | | | | | | | | |
| Protection | Comparative | A3 | Absent | — | C3 | 6 | 10 | 42.2 | 99.99 | 63.6 | 63.33 |
| of one | Example 5 | | | | | | | | | | |
| side | | | | | | | | | | | |
| Protection | Comparative | A5 | Absent | — | C3 | 30 | 7 | 42.5 | 99.99 | 42.5 | 99.99 |
| of both | Example 6 | | | | | | | | | | |
| sides | | | | | | | | | | | |

In Table 1, as for the type of the inorganic layer, B1 represents silicon oxide, B2 aluminum oxide, and B3 silicon nitride. In each of the samples of Comparative Examples 1, 2, 4, and 5 (the thin polarizing films A1 and A3), the transparent protective film was provided on only one side of the polarizer whereas the other side of the polarizer was exposed. Therefore, as a result of the optical reliability test performed on the samples of Comparative Examples 1, 2, 4, and 5, an increase in the single transmittance and a decrease in the degree of polarization occurred due to release of iodine from the polarizer.

TABLE 2

| | Type of first | | | |
|---|---|---|---|---|
| Type of | transparent | Polarizer | | Type of second |
| polarizing | protective | Type and | Water content | transparent |
| film (A) | film | thickness | (g/m²) | protective film |
| A1 | Acryl (40) | PVA (5) | 0.6 | Absent |
| A2 | Acryl (20) | PVA (5) | 0.6 | Absent |
| A3 | COP (40) | PVA (5) | 0.6 | Absent |
| A4 | Absent | PVA (5) | 0.6 | Absent |
| A5 | Acryl (40) | PVA (5) | 0.6 | Acryl (40) |
| A6 | Acryl (40) | PVA (20) | 2.1 | Absent |

TABLE 3

| Acryl-based polymer | | | Crosslinking agent | | | | Coupling agent | |
|---|---|---|---|---|---|---|---|---|
| | Monomer | Weight | | Weight | | Weight | | Weight |
| Type | composition | parts | Type | parts | Type | parts | Type | parts |
| C1 | BA/4HBA = 99/1 | 100 | d1 | 0.1 | d3 | 0.3 | d4 | 0.2 |
| C2 | BA/AA = 95/5 | 100 | d2 | 0.5 | d3 | 0.1 | d4 | 0.2 |
| C3 | BA/2HEA = 99/1 | 100 | d1 | 0.1 | d3 | 0.3 | d4 | 0.2 |
| C4 | BA/4HBA = 99/1 | 100 | d1 | 0.1 | d3 | 0.3 | d5 | 0.2 |
| C5 | BA/4HBA = 99/1 | 100 | d1 | 0.1 | d3 | 0.3 | d6 | 0.2 |

In Table 3, as for the monomer composition of the acryl-based polymer, BA represents butyl acrylate, 4HBA 4-hydroxybutyl acrylate, 2HEA 2-hydroxyethyl acrylate, and AA acrylic acid.

As for the type of the crosslinking agent, d1 represents trimethylolpropane xylylene diisocyanate (Takenate D110N manufactured by Mitsui Chemicals, Inc.), d2 trimethylolpropane tolylene diisocyanate (CORONATE L manufactured by Nippon Polyurethane Industry Co., Ltd.), and d3 benzoyl peroxide (NYPER BMT manufactured by NOF CORPORATION).

As for the type of the coupling agent, d4 represents a silane coupling agent (KBM-403 manufactured by Shin-Etsu Chemical Co., Ltd.), d5 a zirconium coupling agent (Ken-React NZ33 manufactured by Kenrich Petrochemicals, Inc.), and d6 a titanium coupling agent (PLENACT KR-TTS manufactured by Ajinomoto Fine-Techno Co., Inc.).

### DESCRIPTION OF REFERENCE SIGNS

10: polarizer
11: first transparent protective film
12: second transparent protective film
20: inorganic layer
30: the pressure-sensitive adhesive layer

1. A polarizing film, comprising: a polarizer; and an inorganic layer or layers provided on one or both sides of the polarizer.

2. The polarizing film according to claim 1, further comprising a transparent protective film or films provided on one or both sides of the polarizer with or without the inorganic layer(s) interposed therebetween, wherein the inorganic layer on at least one side is an outermost layer.

3. The polarizing film according to claim 2, wherein a first transparent protective film is provided on a first side of the polarizer with no inorganic layer interposed therebetween, and the inorganic layer is provided on only a second side of the polarizer.

4. The polarizing film according to claim 3, wherein the inorganic layer is provided on the second side of the polarizer with a second transparent protective film interposed therebetween.

5. The polarizing film according to claim 1, wherein the inorganic layer comprises an inorganic oxide or an inorganic nitride.

6. The polarizing film according to claim 1, which has a water-vapor permeability of 0.000001 g/m²·day or more and 5 g/m²·day or less as measured at 40° C. and 90% RH.

7. The polarizing film according to claim 1, wherein the polarizer has a thickness of 10 μm or less.

8. The polarizing film according to claim 1, which has a single transmittance of 30% or more and a degree of polarization of 90% or more.

9. A pressure-sensitive adhesive layer attached polarizing film, comprising: the polarizing film according to claim 1; and a pressure sensitive adhesive layer provided on the organic layer of the polarizing film.

10. The pressure-sensitive adhesive layer attached polarizing film according to claim 9, wherein the pressure sensitive adhesive layer is provided directly on the inorganic layer, and the pressure sensitive adhesive layer has an adhesive strength between the inorganic layer and the pressure sensitive adhesive layer of 15 N/25 mm or more.

11. The pressure-sensitive adhesive layer attached polarizing film according to claim 9, wherein the pressure sensitive adhesive layer is made from an acrylic pressure sensitive adhesive comprising a (meth)acryl-based polymer as a base polymer.

12. The pressure-sensitive adhesive layer attached polarizing film according to claim 11, wherein the acrylic pressure sensitive adhesive further comprises a coupling agent.

13. The pressure-sensitive adhesive layer attached polarizing film according to claim 12, wherein the coupling agent is at least one selected from the group consisting of a silane coupling agent, a zirconium coupling agent, and a titanate coupling agent.

14. The pressure-sensitive adhesive layer attached polarizing film according to claim 12, wherein the coupling agent is in an amount of 0.001 to 5 parts by weight based on 100 parts by weight of the (meth)acryl-based polymer.

15. The pressure-sensitive adhesive layer attached polarizing film according to claim 11, wherein the acrylic pressure sensitive adhesive further comprises a crosslinking agent.

16. The pressure-sensitive adhesive layer attached polarizing film according to claim 9, which has a water-vapor permeability of 0.000001 g/m²·day or more and 5 g/m²·day or less as measured at 40° C. and 90% RH.

17. An image display device comprising the polarizing film according to claim 1.

18. An image display device comprising the pressure-sensitive adhesive layer attached polarizing film according to claim 9.
